(19) United States
(12) Patent Application Publication
(10) Pub. No.: US 2005/0270978 A1
(43) Pub. Date: Dec. 8, 2005

(54) Mode selection in MIMO devices

(75) Inventor: Russell John Haines, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/110,742

(22) Filed: Apr. 21, 2005

(30) Foreign Application Priority Data
Jun. 8, 2004 (GB) 0412774.2

(51) Int. Cl. H04L 1/00

(52) U.S. Cl. 370/235; 370/310

(57) ABSTRACT

A signal processing method, particularly in a MIMO wireless communications system, is capable of receiving a DATA frame and responding with transmission of an ACK frame, the ACK frame being of conventional structure in that it contains a reserved portion and an active portion, the ACK frame further containing, in the reserved portion, information defining a transmission mode selection message for interpretation by suitably configured communications apparatus. In such apparatus, the message is interpreted as an indication of the transmission mode, of a plurality available, to be used in future transmissions of frames of information.

This invention relates to the communication of information in a wireless communications system involving multiple input, multiple output (MIMO) devices.

In wireless communication between MIMO devices, communication is effected in a selected one of a plurality of available modes. The selection of a particular mode depends on the quality of communication channel established between two devices, which is greatly affected by environmental effects or physical obstacles in the communication path leading to highly dynamic multi-path effects. In the 802.11a standard (IEEE Computer Society, “Supplement to IEEE Standard for Information technology—Telecommunications and information exchange between systems—Local and metropolitan area networks—Specific requirements—Part 11: Wireless LAN Medium Access Control (MAC) and Physical Layer (PHY) specifications: High-speed Physical Layer in the 5 GHZ Band”, IEEE Std 802.11a-1999, September 1999), the particular algorithm with which devices switch between modes (for example from 64 bit QAM down to BPSK) is undefined and the exact details are left to the particular implementation used.

Regardless of the mode switching algorithm chosen in practice, the only standard-compliant input variable to the algorithm is the presence or absence of an acknowledgement frame (ACK) (or the clear to send (CTS) in a ready-to-send/clear-to-send (RTS/CTS) exchange) to indicate whether a data frame (DATA) (or the RTS in an RTS/CTS exchange) was received successfully. In practice a time period (the time-out period) is defined within which an ACK must arrive if absence is not to be determined. This is the only mechanism for feeding back the information from a receiver to a transmitter in an 802.11a system.

The absence of an ACK frame at a device previously transmitting a DATA frame may occur for one of a plurality of reasons, such as:
The DATA frame was never received (e.g. deep fade).
The DATA frame was destructively interfered with.
The ACK frame was never received (e.g. deep fade).
The ACK frame was destructively interfered with.
The receiver has “ceased to exist” (for instance it has been switched off or is out of range).

It will be appreciated that this is not an exhaustive list and that other causes of failure for a transmitter device in an 802.11a system to receive an ACK frame in response to transmission of a DATA frame could arise. Nonetheless, whatever the real cause of failure for an ACK frame to be received, the only response available to the transmitter is to adjust the modulation scheme (the mode) to use a more robust mode, which could have an impact on transmission speeds. The particular number of “steps” by which the transmission speed of the modulation scheme is reduced (and therefore the robustness of the modulation scheme increased) is a matter for a specific implementation.

In contrast, functionality should also be provided such that, in times of successful and reliable transmission, a device should attempt to increase transmission speed by changing the modulation scheme accordingly. Successful and/or reliable transmission can be indicated by successful receipt of ACK frames on a regular basis. The number of “steps” by which the modulation scheme is increased, and at what point, is again implementation dependent. One example would be to change the selection of modulation scheme to one with a higher transmission speed than the present scheme, after a particular period of time in which transmission has been successfully completed in a particular mode, or after a particular number of successful exchanges of packets in a given mode. More sophisticated schemes may also exist, taking into account more (often proprietary) variables and applying more complex and intelligent analysis to the situation.

It will be appreciated that the rate of change of a standard single input, single output (SISO) channel in an 802.11a system is sufficiently slow that the time out mechanism (the means with which the absence of an ACK frame is determined) is a feasible feedback mechanism with which to make any necessary adjustments to the selection of the modulation scheme concerned. However, in a MIMO channel, the rate of change of the channel is much greater, with many more factors influencing the choice of the modulation and coding scheme (MCS).

As any improvement on the provisions of a standard, such as the 802.11a standard, will lead to an extension of that technology, it is important that any improvement on this standard technology takes into account the impact on “legacy” technology. In the case of 802.11a, a legacy terminal will be unable to decode the data exchange duration in a MIMO encoded frame and so the terminal will enter a “fail safe” state which involves it backing off from the medium (i.e. not monitoring for communication frames) for a greatly extended period of time (described in the standard as the Extended Inter-Frame System, EIFS). In this state, the terminal suspends any attempts to gain access to the communications medium for this extended period of time, as it is unable to determine when the medium will next be free.

Though it will be appreciated that the carrier-sense functionality in the device would allow it to detect that the medium is free, it would not be able to sense transmissions from any hidden nodes, so any attempt to transmit could collide with a hidden node's transmission.

While this will not affect the operation of a terminal specifically designed to receive the frame duration information, a terminal designed in accordance with 802.11a (a “legacy” terminal) will suffer substantially reduced operation performance, as it will be unable to contend for access on a fair and equitable basis when the current high-rate data exchange has actually ended, giving unfair and unintentional priority to the new, non-legacy terminals. In short, this system would not be backwards compatible. Terminals in accordance with 802.11a would at least be massively disadvantaged and at worst rendered completely mute (given sufficient non-legacy terminals with high traffic loading) which would have inherent implications for future sales of such standards-based technology.

It is thus an object of the present invention to provide a system whereby frame duration information can be provided in a substantially MIMO encoded frame, such that the frame encoded information can be decoded by a device constructed in accordance with the IEEE 802.11a standard.

According to one aspect of the invention, a wireless communications system provides acknowledgement means for acknowledging receipt of a message, the acknowledgement means being operable to generate and send a message in a predetermined format, said format comprising at least one active portion storing acknowledgement information readable by another device and at least one feedback portion carrying an instruction to use a particular one of a plurality of available transmission modes in future transmissions of information.

The feedback portion is preferably defined in said acknowledgement message in a reserved portion of said message, otherwise not required for the carrying of acknowledgement information. In that way, a device in receipt of an acknowledgement message not configured to receive information in said feedback portion can operate with a device capable of sending such a message.

According to another aspect of the invention, there is provided a method of processing a signal received in a communications system, the signal defining a data frame of predetermined structure and transmitted at an identified transmission modulation mode selected from a predetermined set of modulation modes, the method comprising selecting a transmission mode, from said set of modulation modes, for future transmission of frames of data, defining a receipt acknowledgement frame for transmission to the originator of said received frame, the acknowledgement frame being of a predetermined structure and comprising one or more sequences of reserved bits not allocated to recording acknowledgement in a device sending a data frame, of successful receipt of said data frame, at least one of said reserved bits being allocated to hold information identifying the selected transmission mode for future transmission of frames of data and sending the receipt acknowledgement frame to the source of the received signal.

In one configuration, the acknowledgement frame may comprise a field of a predetermined number of bits, a first subset of said bits being allocated in use to bear initialisation values to enable initialisation of a method of receiving said acknowledgement frame, and a second subset of said bits, exclusive of said first subset, not allocated to said initialisation, at least one of said bits of said second subset being used in said defining step, as said one or more reserved bits for holding information identifying the selected transmission mode for future transmission of frames of data.

In another configuration, the acknowledgement frame may be suitable to be transmitted by a symbol-based transmission modulation scheme and the acknowledgement frame comprises one or more pad bits inserted to render the total number of bits in the acknowledgement frame an integer multiple of a number of bits associated with a symbol of said symbol-based transmission modulation scheme, at least one of said pad bits being used in said defining step, as said one or more reserved bits for holding information identifying the selected transmission mode for future transmission of frames of data.

The one or more reserved bits may define a value which maps to an entry in a stored list of available transmission modes, thereby indexing explicitly to a transmission mode for future use.

Another aspect of the invention provides a method of processing a signal received in a communications system, the signal defining an acknowledgement frame of predetermined structure and identifying a transmission modulation mode selected from a predetermined set of modulation modes, the method comprising extracting a bit or a sequence of bits from said acknowledgement frame, said bits otherwise having no consequence in the processing of the acknowledgement frame, looking up, in a look up table of available transmission modes to use for future transmission of data, a particular transmission mode corresponding to the bit or sequence of bits, and adopting the particular transmission mode as the transmission mode to be used for future transmission of data in the absence of instruction to the contrary.

Another aspect of the invention provides a method of communicating data in a wireless MIMO system, the method comprising the steps of transmitting a frame of data from a first node to a second node in said system, at a particular transmission mode of a plurality of available transmission modes, determining, on receipt of said frame at said second node, whether said transmission mode is to be used for future transmission of data, and embedding, in an acknowledgement frame comprising an acknowledgement message, information indicating a transmission mode of said plurality to be used by said first node in future transmissions, such that, in the event that said first node is not configured to extract and respond to said embedded information, it remains capable of receiving and interpreting the acknowledgement message in said acknowledgement frame.

Another aspect of the invention provides a communications device operable to process a signal received in a communications system, the signal defining a data frame of predetermined structure and transmitted at an identified transmission modulation mode selected from a predetermined set of modulation modes, the apparatus comprising mode selection means for selecting a transmission mode, from said set of modulation modes, for future transmission of frames of data, acknowledgement frame generating means for defining a receipt acknowledgement frame for transmission to the originator of said received frame, the acknowledgement frame being of a predetermined structure and comprising one or more sequences of reserved bits not allocated to recording acknowledgement in a device sending a data frame, of successful receipt of said data frame, at least one of said reserved bits being allocated to hold information identifying the selected transmission mode for future transmission of frames of data, and signal transmission means for sending the receipt acknowledgement frame to the source of the received signal.

In one configuration the acknowledgement frame generating means may be operable to generate a receipt acknowledgement frame comprising a field of a predetermined number of bits, a first subset of said bits being allocated in use to bear initialisation values to enable initialisation of a method of receiving said acknowledgement frame, and a second subset of said bits, exclusive of said first subset, not allocated to said initialisation, at least one of said bits of said second subset being used in said defining step, as said one or more reserved bits for holding information identifying the selected transmission mode for future transmission of frames of data.

In another configuration, the acknowledgement frame generating means may be operable to generate a receipt acknowledgement frame suitable to be transmitted by a symbol-based transmission modulation scheme and the acknowledgement frame comprises one or more pad bits inserted to render the total number of bits in the acknowledgement frame an integer multiple of a number of bits associated with a symbol of said symbol-based transmission modulation scheme, at least one of said pad bits being used in said defining step, as said one or more reserved bits for holding information identifying the selected transmission mode for future transmission of frames of data.

The one or more reserved bits may define a value which maps to an entry in a stored list of available transmission modes, thereby indexing explicitly to a transmission mode for future use.

Communications device operable to process a signal received in a communications system, the signal defining an acknowledgement frame of predetermined structure and identifying a transmission modulation mode selected from a predetermined set of modulation modes, the method comprising extracting a bit or a sequence of bits from said acknowledgement frame, said bits otherwise having no consequence in the processing of the acknowledgement frame, looking up, in a look up table of available transmission modes to use for future transmission of data, a particular transmission mode corresponding to the bit or sequence of bits, and adopting the particular transmission mode as the transmission mode to be used for future transmission of data in the absence of instruction to the contrary.

The invention also provides a computer program product which stores machine readable data defining computer executable instructions, the instructions being capable of configuring a computer to operate a method, or as apparatus, substantially in accordance with any of the aspects of the invention set out above.

The invention further provides a computer readable signal which carries machine receivable data defining computer executable instructions, the instructions being capable of configuring a computer to operate a method, or as apparatus, substantially in accordance with any of the aspects of the invention set out above.

Further aspects, features and advantages of the invention will become apparent from the following description of certain specific embodiments of the invention, together with variations thereon, made with reference to the accompanying drawings in which:

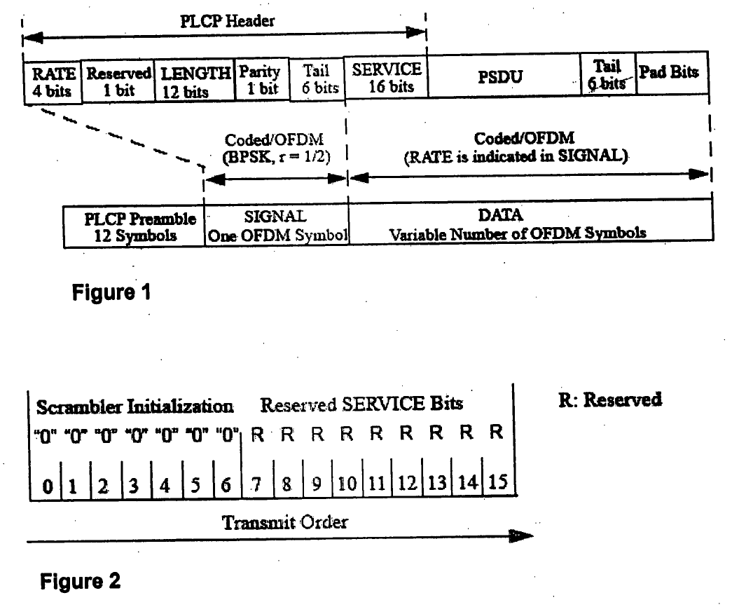

FIG. 1 is a schematic diagram of a data packet structure for a PPDU in accordance with the IEEE 802.11a standard;

FIG. 2 is a schematic diagram of a SERVICE field format of the data packet structure illustrated in FIG. 1;

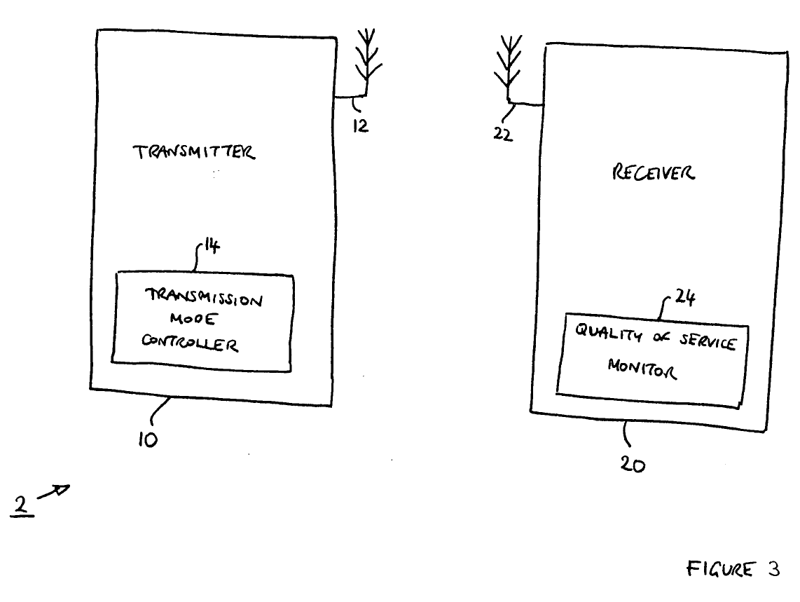

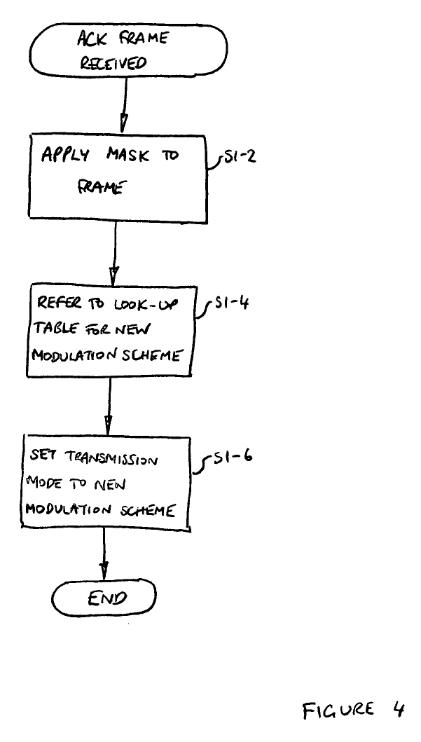

FIG. 3 is a schematic diagram of a wireless MIMO communications system configured in accordance with a specific embodiment of the invention;

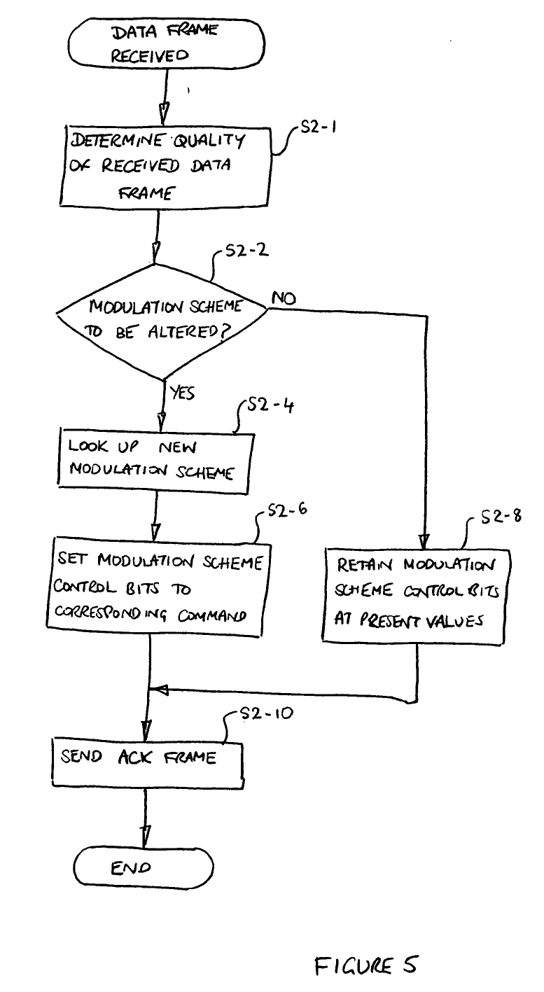

FIG. 4 is a flow diagram of a process performed in a transmission mode controller of a transmitter of the system illustrated in FIG. 3, on receipt of an ACK frame from the receiver; and

FIG. 5 is a flow diagram of a process performed in a quality of service monitor of a receiver of the system illustrated in FIG. 4, on receipt of a DATA frame from the transmitter.

FIGS. 1 and 2 illustrate an example of communication between two devices using the 802.11a standard. The construction of the PHY Protocol Data Unit (PPDU) by the PHY moves data from bytes to OFDM symbols capable of carrying a large number of bits. In the case of the highest rate mode available in 802.11a, 216 bits are carried, i.e. 27 bytes.

As shown in FIGS. 1 and 2, the PPDU comprises a 12-symbol preamble, then a single BPSK OFDM symbol containing the SIGNAL field and finally the DATA field. The DATA field comprises a PSDU, 16 SERVICE bits and 6 Tail bits, and pad bits to ensure the total number of bits in the DATA field corresponds with an integer number of OFDM symbols.

In terms of the duration of the PPDU, the PLCP preamble takes 16 μs, the SIGNAL field takes 4 μs, and each OFDM symbol takes 4 μs. It is an important feature of the PPDU frame construction that, as the rate and amount of data content are variable, so there will be a variable number of pad bits required to fill an integer number of OFDM symbols. For certain situations where the stations must be able to calculate the size or duration of a frame, there are specific rules which dictate the rate at which various frame types can be transmitted under various circumstances.

The rules governing rate selection (specifically, the rates at which control frames can be transmitted) vary slightly between the different amendments of the 802.11 standard, but the latest published version is to be found in the 802.11 2003 edition (IEEE Computer Society, “IEEE Wireless LAN Edition—A compilation based on IEEE Std 802.11 TM-1999 (R2003) and its amendments”, ISBN 0-7381-3572-0 SE95082, September 2003) read in conjunction with the 802.11g amendment (IEEE Computer Society, “IEEE Standard for Information technology—Telecommunications and information exchange between systems—Local and metropolitan area networks—Specific requirements Part 11: Wireless LAN Medium Access Control (MAC) and Physical Layer (PHY) specifications Amendment 4: Further Higher Data Rate Extension in the 2.4 GHz Band”, IEEE Std 802.11g™-2003, June 2003).

In order to further explain these rules in the context of the present invention, it is helpful to provide certain definitions. The basic organisational unit of an 802.11-family wireless LAN is the Basic Service Set (BSS), a grouping of WLAN devices sharing a common channel and identification code (BSS-ID). A BSS parameter is the BSSBasicRateSet, which is the set of modes with which all STA in the BSS can communicate (i.e. the set of lowest common denominator modes). The BSSBasicRateSet can vary from BSS to BSS. This set is broadcast in the periodic Beacon frames to advertise this minimum requirement for new STAs to join the BSS. Beacons are generated by the AP in an infrastructure BSS, and in a distributed fashion by any STA according to a random selection process in an independent BSS (IBSS). Another pertinent parameter is the Mandatory PHY Rate set, which defines the modes for a given standard PHY that must be supported by any compliant terminal; note that this Mandatory PHY Rate set is fixed for each PHY standard (although not all PHY standards specify such a set), and is, logically, a subset of the BSSBasicRateSet.

Table 1 sets out the mandatory and optional rates for a selection of 802.11 standard PHYs.

TABLE 1

| PHY | Mandatory Rates (Mbps) | Optional Rates (Mbps) |
|---|---|---|
| 802.11 FHSS | 1 | 2 |
| 802.11 DSSS | — | 1, 2 |
| 802.11a DSSS | 6, 12, 24 | 9, 18, 48, 54 |

In 802.11 DSSS, 1 Mbps is defined as “Basic” and 2 Mbps as “Enhanced” but neither is mandatory.

Thus, the latest rules governing rate selection, as referred to above, are defined in terms of the BSSBasicRateSet and the Mandatory PHY Rate set.

In accordance with one rate selection rule of the 802.11g Standard, for a DATA (or RTS) frame sent at rate R_{DATA} with modulation M_{DATA}, if a rate R_{BASIC} (with modulation M_{BASIC}) exists in the BSSBasicRateSet that satisfies R_{BASIC}≦R_{DATA} and M_{DATA}=M_{BASIC}, then the ACK (or CTS) is to be sent at that rate. However, if more than one rate satisfies those conditions then the highest rate that satisfies those conditions is to be used. Otherwise, if no rate in the BSSBasicRateSet satisfies those conditions, the ACK (or CTS) is to be sent at the highest rate R_{MAND} with modulation M_{MAND} in the Mandatory PHY Rate set for that PHY.

Given that the 802.11g addendum introduces complementary DSSS and OFDM schemes, modulation should be assumed to mean the distinction between these two schemes. As such, the requirement for the “modulation” to be the same can be disregarded, because all rates offered by the 802.11a PHY are OFDM. Given this assumption, the rate selection process can be simplified as determining, for a DATA (or RTS) frame sent at rate R_{DATA}, if there is a rate R_{BASIC} in the BSSBasicRateSet that satisfies R_{BASIC}≦R_{DATA}. If so, then the ACK (or CTS) is sent at that rate if more than one rate satisfies those conditions then the highest rate that satisfies those conditions is to be used. Otherwise, if no rate in the BSSBasicRateSet satisfies that requirement, the ACK (or CTS) is to be sent at the highest rate R_{MAND} in the Mandatory PHY Rate set for that PHY.

This differs from the original 802.11 rules, as the original rules set the ACK at the highest rate in the BSSBasicRateSet, whereas these 802.11g rules set the ACK at the highest rate in the BSSBasicRateSet up to and including the rate at which the DATA transmission was made.

It will be appreciated that it is generally reasonable to assume that transmission rates in communications standards yet to be determined will be greater than those achievable by 802.11a. Thus, the rates that will be provided in the future are unlikely to be one of the PHY rates mandatory in 802.11a. In order to ensure that a device constructed in accordance with the 802.11a standard is capable of receiving an ACK frame from a device constructed in accordance with a later defined standard, the rate of transmission of an ACK frame should be set to the highest rate of the legacy BSSBasicRateSet. This ensures that the transmission is legacy friendly and also satisfies the rules relating to the selection of a rate in accordance with later versions of 802.11, such as 802.11g.

As the newer standard system will have control of the BSS, the BSSBasicRateSet as communicated to legacy terminals can be controlled. The exact rates that need to be used in the BSSBasicRateSet are not important to the understanding of this invention—it is sufficient that it is appreciated that the BSSBasicRateSet maximum value will be at least 24 Mbps.

An exemplary communications system 2 is illustrated in FIG. 3. The system 2 comprises a transmitter 10 and a receiver 20, both configured to operate in accordance with a MIMO wireless communications protocol based on established standard communications methods. The transmitter 10 and the receiver 20 each comprise respective MIMO antennas 12, 22, for effecting this wireless communication.

The transmitter 10 is of substantially conventional construction and function, and can be implemented for example by means of software executed on a suitably configured computer, and/or an application specific computing device.

The transmitter 10 further comprises a transmission mode controller 14, operable in accordance with either of a first or second embodiment of the invention, to control the mode by which MIMO wireless transmission is effected, selected from a plurality of available modes of various levels of robustness and transmission speeds.

Similarly, the receiver 20 comprises a quality of service monitor 24 operable to determine a quality of service associated with packets of data transmitted by the transmitter 10, and to return a command, embedded in an acknowledgement (ACK) frame back to the transmitter 10 in response to receipt of a DATA packet. The command instructs the transmitter as to the transmission mode to be used in future transmissions.

Two specific embodiments of the invention will now be described with reference to the drawings, in each of which the purpose is to carry mode selection feedback information within an acknowledgement (ACK) frame. In each case, the exact size and format of the mode selection feedback information is not described, though it will be appreciated that the invention can be applied to any communications method within the scope of the 802.11 standard, or other communications standards employing similar principles.

In a first specific embodiment of the invention, the communication of information in the ACK frame takes advantage of the structure of the SERVICE frame as defined in the 802.11 standard. The 16-bit SERVICE field (as illustrated in FIG. 2) is defined as comprising of seven zeroes (scrambler initialisation) and nine “reserved” bits. In this first embodiment, feedback flow makes use of these reserved bits, or at least a subset thereof. It will be understood that, with nine reserved bits available for use in this way, up to 512 unique messages could be returned to the receiver of the ACK frame—this number may be unnecessary given the number of different operational instructions that would be necessary in a particular implementation.

The method by which the transmission mode controller 14 and the quality of service monitor 24 operate, in accordance with the first embodiment will now be described, with reference to FIGS. 4 and 5.

FIG. 4 illustrates the operation of the transmission mode controller 14 in response to the receipt of an ACK frame. In a first step S1-2 a mask is applied to the frame, to extract those of the nine “reserved” bits that have been allocated to the feedback flow of transmission mode control information. If, for example, a MIMO wireless communications system provides seven transmission modes, then three of the reserved bits will be capable of encoding commands corresponding with explicit instruction to use one of the seven available transmission modes. Thus, in that example, the mask applied in step S1-2 will extract those three bits.

Then in step S1-4, a lookup table is referred to map the values of the bits extracted in the previous step with a corresponding transmission mode. Finally, the transmission mode controller 14 then sets, in step S1-6, the transmission mode to be used in future transmission to the new modulation scheme identified in the lookup step in step S1-4. The process then ends.

FIG. 5 illustrates corresponding behaviour of the quality of service monitor 24 in operation, on receipt of a data frame. In a first step S2-1, the quality of the data frame that has been received is determined. In this example, this can be achieved by inspecting the “confidence” values associated with each bit in the soft-decoder. The soft decoder (not illustrated) is of conventional construction and outputs an indication as to the level of confidence in the value of each bit received, whether it has been determined to be a ‘one’ or a ‘zero’.

The principle of this method is that, if all the bits are being decoded with poor confidence levels, then the coding scheme needs to be changed to a more robust, but perhaps with a lower transmission rate. Conversely, if the bits are being decoded with 100 or near 100% confidence levels, and higher-rate schemes above the current one are available, then it can be determined that using a scheme with a higher transmission rate but, in return, a lower level of robustness, could be appropriate.

Thus, in S2-2, the quality of service monitor 24 determines if the modulation scheme currently in use should be altered, taking account of either the number of successful transmissions consecutively or in a specific period of time, or the number of unsuccessful transmissions consecutively or in a specific period of time, or another measure. If the modulation scheme, on the basis of past results, is to be altered, then in step S2-4, the most appropriate new modulation scheme to be used in looked up in a lookup table, which returns a command consisting of a use of control bits to be inserted in an acknowledgement frame ACK.

In the specific case of a system compliant with the 802.11 standard, the MAC is provided with a configuration parameter “dot11SupportDataRatesTx” which resides in a management information base (MIB) which describes which data rates are supported by the underlying PHY, to enable the MAC to select the most appropriate one from them. In the definition of a particular PHY in the appropriate standard, the range of values permissible for this parameter is given, and any mandatory rates are noted.

Then in step S2-6, the control bits in the ACK frame are set to the values corresponding with the selected modulation scheme.

Conversely, if the modulation scheme is not to be altered, then in step S2-8 the modulation scheme control bits previously used in previous ACK frames are retained in their present values.

In step S2-10, following either step S2-6 of step S2-8, the acknowledgement frame suitably configured with the control bits in the appropriate ones of the nine “reserved” bits as described above, is sent.

In a second specific embodiment of the invention, the communication of feedback information in the ACK frame takes advantage of the structure of the Pad Bits inserted into the DATA section of the PPDU, as illustrated in FIG. 1 of the drawings. The existing standard currently specifies that the values of the pad bits are zeros. However, the present embodiment takes advantage of the fact that a legacy device is not affected by the actual value of these bits and they can in fact assume any value.

In the case of an ACK frame, the PSDU is an ACK MAC frame of 14 bytes. Added to this are the 16 bits of the SERVICE field and the 6 bits of TAIL, leading to a total of 134 bits. Depending on the rate employed to transmit the ACK frame, the number of pad bits, to supplement this 134 to an integer number of OFDM symbols, ranges from 10 (in most cases) to 82 (at the highest rate), as shown in table 2 below:

TABLE 2

| | | | Data bits per | OFDM | Number of |
|---|---|---|---|---|---|
| Data Rate | | Code | OFDM | Symbols | Pad Bits |
| (Mbps) | Mode | Rate | symbol | per ACK | Available |
| 6 (mandatory) | BPSK | ½ | 24 | 6 | 10 |
| 9 | BPSK | ¾ | 36 | 4 | 10 |
| 12 (mandatory) | QPSK | ½ | 48 | 3 | 10 |
| 18 | QPSK | ¾ | 72 | 2 | 10 |
| 24 (mandatory) | 16-QAM | ½ | 96 | 2 | 58 |
| 36 | 16-QAM | ¾ | 144 | 1 | 10 |
| 48 | 64-QAM | ⅔ | 192 | 1 | 58 |
| 54 | 64-QAM | ¾ | 216 | 1 | 82 |

The number of pad bits in each case is calculated in accordance with a method now demonstrated with reference to the first line of table 2. The number of bits in the ACK frame without the pad bits (134) is divided by the number of bits in an OFDM symbol (24) in the mode concerned. Then, the result of this calculation (5.58) is rounded up to the nearest integer (6) to give the actual number of OFDM symbols that will need to be employed in communicating the ACK frame. This number of OFDM symbols provides the actual number of bits (144) of which the ACK frame will be composed, and the difference between this actual number of bits, and the number of bits that the ACK frame requires without pad bits, is the number of pad bits (10).

Since there will always be at least 10 pad bits at the end of an ACK frame, these are used in this embodiment to provide the required feedback data. A fixed number of pad bits, less than or equal to the minimum number available, are in this embodiment replaced with the feedback information. Since up to 10 bits can thus be employed to carry this feedback information, up to 1024 unique feedback messages can be defined.

Thus, the second embodiment provides that the transmission mode controller 14 and the quality of service monitor 24 operate in largely the same manner as in the first embodiment, with reference to FIGS. 4 and 5 respectively. Exceptions to this concern the operation of the mask in step S1-2: the mask is applied to a different part of the ACK frame, namely the pad bits. In order to take account of the fact that a different number of pad bits may be provided in different transmission modes, the most significant pad bits would be the most appropriate to use to contain information defining a new transmission modulation scheme to be used.

With full control of the BSSBasicRateSet, the maximum rate could be set to the mandatory 24 Mbps, giving an optimum trade off between reliability (low coding rate) and feedback payload (number of pad bits available, 58 in this case), although this is at the cost of requiring two OFDM symbols per ACK. Alternatively, the 48 Mbps rate could be set as the maximum BSSBasicRateSet to make the ACK shorter in duration (Oust one OFDM symbol), but a BSSBasicRateSet such as that would restrict the number of legacy terminals able to join the BSS (which may be no bad thing), as well as reducing the robustness of the ACK frame.

In use in either of the operational embodiments represented above, a transmitter has a standardised table of different MCS modes. On reception of a frame encoded using a particular mode m, the receiver considers, in step S2-2, factors such as the confidence measurements in the soft-decoding algorithm, to determine whether the performance at that mode is acceptable. It then includes in the feedback bits in the ACK frame (either the reserved SERVICE bits in the first embodiment or the Pad Bits in the second embodiment) the index into the MCS table for mode m′, the mode at which the next transmission should be made. This new mode could be the same as m; equally it doesn't have to be adjacent to m in the table—the number of bits which may be available for use in an ACK frame is, in the illustrated examples, sufficient that explicit referencing of a new transmission mode is possible and thus appropriate for use, rather than implicit referencing wherein only small step changes in the robustness and/or transmission speeds is possible.

For example, if, due to movement of one or more of the transmitter and receiver, the link suddenly changes from cluttered non line-of-sight (NLOS) to line-of-sight (LOS) then a large change in the transmission rate and thus the level of robustness may be required, and the present invention allows this by including an explicit instruction to use a particular transmission mode from the next transmission onwards.

Any suitable method for determining the rate at which the ACK should be sent can be used, in accordance with this described embodiment. The determination of this rate depends on the number of bits that need to be sent back to the transmitter.

In 802.11a, and other comparable communications systems, the transmission mode is selected by the transmitter. The present invention provides a method performed at the receiver of a packet of information, for determination of a transmission mode of a later transmitted packet of information. This is advantageous as the receiver is well disposed to determine the condition of a signal on receipt of that signal, and to communicate relevant information to the sender of that signal in a suitably configured ACK frame. Moreover, the above description demonstrates methods of communicating with a sender of a packet of information in such a manner that efficient communication can be maintained, rather than sending back substantial amounts of signal quality information such as is described in International Patent Application WO2004002049.

In accordance with the invention, the transmission mode is to be selected from a predetermined list of modes. For the effective implementation of standard technology, an OperationalRateSet is determined, which is the full set of modes at which a device can transmit and receive. This is, by definition, a superset of the BSSBasicRateSet. A device can thus be prevented from transmitting to another device at a rate that the recipient does not support.

It will be appreciated that various implementations, employing different combinations of software and hardware, are possible with this invention. Further, software products, such as comprising computer executable instructions stored on computer readable storage media, or carried on computer receivable signals, can be used with suitably receptive computer hardware, to implement either of the transmitter or receiver described herein.

Further, the described embodiments have been used to exemplify the invention in terms of separate transmitters and receivers. However, it will be appreciated that wireless communications devices will be presented which offer the function, in combination, of a transmitter and a receiver, and it will be appreciated that the intention in separating these functions out in this example was for reasons of clarity, and not with any implication as to the exclusivity of these functions.

Further, it will be appreciated that in the context of the first embodiment, any packet containing apparently reserved bits can offer the facility to contain information selecting a transmission mode for future communication. In particular, any packet containing reserved SERVICE bits (or, indeed, any other range of bits otherwise reserved from use in communication) can have certain of those bits set aside for use in indicating a transmission mode to be used.

It will be understood that the illustrated examples take advantage of the number of bits available for use to indicate explicitly the transmission mode to be used in future communication. It will be appreciated that, in circumstances where, for example, fewer bits are available, an implicit coding system can be employed, where changes in transmission mode are indicated, rather than a one-to-one correspondence between combinations of transmission mode selection bits and available transmission modes.

1. A method of processing a signal received in a communications system, the signal defining a data frame of predetermined structure and transmitted at an identified transmission modulation mode selected from a predetermined set of modulation modes, the method comprising:
selecting a transmission mode, from said set of modulation modes, for future transmission of frames of data;
defining a receipt acknowledgement frame for transmission to the originator of said received frame, the acknowledgement frame being of a predetermined structure and comprising one or more sequences of reserved bits not allocated to recording acknowledgement in a device sending a data frame, of successful receipt of said data frame, at least one of said reserved bits being allocated to hold information identifying the selected transmission mode for future transmission of frames of data; and
sending the receipt acknowledgement frame to the source of the received signal.

2. A method in accordance with claim 1 wherein the acknowledgement frame comprises a field of a predetermined number of bits, a first subset of said bits being allocated in use to bear initialisation values to enable initialisation of a method of receiving said acknowledgement frame, and a second subset of said bits, exclusive of said first subset, not allocated to said initialisation, at least one of said bits of said second subset being used in said defining step, as said one or more reserved bits for holding information identifying the selected transmission mode for future transmission of frames of data.

3. A method in accordance with claim 1 wherein the acknowledgement frame is suitable to be transmitted by a symbol-based transmission modulation scheme and the acknowledgement frame comprises one or more pad bits inserted to render the total number of bits in the acknowledgement frame an integer multiple of a number of bits associated with a symbol of said symbol-based transmission modulation scheme, at least one of said pad bits being used in said defining step, as said one or more reserved bits for holding information identifying the selected transmission mode for future transmission of frames of data.

4. A method in accordance with claim 2 wherein the one or more reserved bits define a value which maps to an entry in a stored list of available transmission modes, thereby indexing explicitly to a transmission mode for future use.

5. A method in accordance with claim 3 wherein the one or more reserved bits define a value which maps to an entry in a stored list of available transmission modes, thereby indexing explicitly to a transmission mode for future use.

6. A method of processing a signal received in a communications system, the signal defining an acknowledgement frame of predetermined structure and identifying a transmission modulation mode selected from a predetermined set of modulation modes, the method comprising:
extracting a bit or a sequence of bits from said acknowledgement frame, said bits otherwise having no consequence in the processing of the acknowledgement frame, looking up, in a look up table of available transmission modes to use for future transmission of data, a particular transmission mode corresponding to the bit or sequence of bits; and
adopting said particular transmission mode as the transmission mode to be used for future transmission of data in the absence of instruction to the contrary.

7. A method of communicating data in a wireless MIMO system comprising the steps of:
transmitting a frame of data from a first node to a second node in said system, at a particular transmission mode of a plurality of available transmission modes;
determining, on receipt of said frame at said second node, whether said transmission mode is to be used for future transmission of data; and
embedding, in an acknowledgement frame comprising an acknowledgement message, information indicating a transmission mode of said plurality to be used by said first node in future transmissions, such that, in the event that said first node is not configured to extract and respond to said embedded information, it remains capable of receiving and interpreting the acknowledgement message in said acknowledgement frame.

8. Communications device operable to process a signal received in a communications system, the signal defining a data frame of predetermined structure and transmitted at an identified transmission modulation mode selected from a predetermined set of modulation modes, the apparatus comprising:
mode selection means for selecting a transmission mode, from said set of modulation modes, for future transmission of frames of data;
acknowledgement frame generating means for defining a receipt acknowledgement frame for transmission to the originator of said received frame, the acknowledgement frame being of a predetermined structure and comprising one or more sequences of reserved bits not allocated to recording acknowledgement in a device sending a data frame, of successful receipt of said data frame, at least one of said reserved bits being allocated to hold information identifying the selected transmission mode for future transmission of frames of data; and
signal transmission means for sending the receipt acknowledgement frame to the source of the received signal.

9. Device in accordance with claim 8 wherein the acknowledgement frame generating means is operable to generate a receipt acknowledgement frame comprising a field of a predetermined number of bits, a first subset of said bits being allocated in use to bear initialisation values to enable initialisation of a method of receiving said acknowledgement frame, and a second subset of said bits, exclusive of said first subset, not allocated to said initialisation, at least one of said bits of said second subset being used in said defining step, as said one or more reserved bits for holding information identifying the selected transmission mode for future transmission of frames of data.

10. Device in accordance with claim 8 wherein the acknowledgement frame generating means is operable to generate a receipt acknowledgement frame suitable to be transmitted by a symbol-based transmission modulation scheme and the acknowledgement frame comprises one or more pad bits inserted to render the total number of bits in the acknowledgement frame an integer multiple of a number of bits associated with a symbol of said symbol-based transmission modulation scheme, at least one of said pad bits being used in said defining step, as said one or more reserved bits for holding information identifying the selected transmission mode for future transmission of frames of data.

11. Device in accordance with claim 8 wherein the one or more reserved bits define a value which maps to an entry in a stored list of available transmission modes, thereby indexing explicitly to a transmission mode for future use.

12. Device in accordance with claim 8 wherein the one or more reserved bits define a value which maps to an entry in a stored list of available transmission modes, thereby indexing explicitly to a transmission mode for future use.

13. Communications device operable to process a signal received in a communications system, the signal defining an acknowledgement frame of predetermined structure and identifying a transmission modulation mode selected from a predetermined set of modulation modes, the method comprising:
extracting a bit or a sequence of bits from said acknowledgement frame, said bits otherwise having no consequence in the processing of the acknowledgement frame, looking up, in a look up table of available transmission modes to use for future transmission of data, a particular transmission mode corresponding to the bit or sequence of bits; and
adopting said particular transmission mode as the transmission mode to be used for future transmission of data in the absence of instruction to the contrary.

14. Computer program product storing computer readable instructions which, when executed on a computer, cause said computer to become configured to perform the method of processing a signal in accordance with any of claims 1 to 6.

15. Computer program product storing computer readable instructions which, when executed on a computer, cause said computer to become configured to perform the method of communicating a signal in a communications system in accordance with claim 7.

16. Computer program product storing computer readable instructions which, when executed on a computer, cause the computer to become configured as a communications device in accordance with any of claims 8 to 12.

17. Computer readable signal carrying computer readable instructions which, when executed on a computer, cause said computer to become configured to perform the method of processing a signal in accordance with any of claims 1 to 6.

18. Computer readable signal carrying computer readable instructions which, when executed on a computer, cause said computer to become configured to perform the method of communicating a signal in a communications system in accordance with claim 7.

19. Computer readable signal carrying computer readable instructions which, when executed on a computer, cause the computer to become configured as a communications device in accordance with any of claims 8 to 12.
